(19) United States
(12) Patent Application Publication
(10) Pub. No.: US 2026/0048706 A1
(43) Pub. Date: Feb. 19, 2026

(54) INSULATED PASSAGE SYSTEM

(71) Applicant: SIKA TECHNOLOGY AG, Baar (CH)

(72) Inventors: Henri COUSIN, Villeneuve d'Ascq (FR); Philipp KLINGLER, Richterswil (CH); Henrik LINDGREN, Feluy (BE); Noah MUNZINGER, Zürich (CH)

(73) Assignee: SIKA TECHNOLOGY AG, Baar (CH)

(21) Appl. No.: 19/101,108

(22) PCT Filed: Aug. 23, 2023
(86) PCT No.: PCT/EP2023/073187

§ 371 Date: Feb. 4, 2025

(30) Foreign Application Priority Data
Aug. 24, 2022 (EP) 22191935.0

(51) Int. Cl. B60R 13/08

(52) U.S. Cl. CPC B60R 13/0846; B60R 2013/0807; B60Y 2200/91

(57) ABSTRACT

A system of an insulated passage in an electrically driven motor vehicle includes a passage which connects a first region to a second region, wherein the first region is air-permeable in the direction toward a battery of the motor vehicle and wherein the second region is air-permeable in the direction toward a passenger compartment of the motor vehicle. The system further includes an insulating element which includes an expanded material, wherein the expanded material closes the passage against the first region and wherein the expanded material is a one-component thermally cured epoxy resin composition.

The invention relates to a system of an insulated passage and in particular a system of an insulated passage in an electrically driven motor vehicle.

In electrically driven motor vehicles, there is additionally the problem, besides the usual acoustic insulation, that an inner space of the motor vehicle has to be protected for incidents of a malfunction of the drive battery. If the battery of the electrically driven motor vehicle thermally runs away, or overheats in an exothermic chemical reaction, poisonous and very hot gases are developed. These poisonous, hot gases have to be kept away from the passenger compartment of the motor vehicle for a specific minimum time so that occupants inside the motor vehicle can be brought to safety in good time.

Therefore, an object of the present invention is to provide an apparatus which allows thermal, poisonous, hot gases which are generated during a thermal runaway of the battery of an electrically driven motor vehicle to be able to be kept away from the passenger compartment.

This object is achieved by a system of an insulated passage in an electrically driven motor vehicle, the system comprising: a passage which connects a first region to a second region, wherein the first region is air-permeable in the direction toward a battery of the motor vehicle and wherein the second region is air-permeable in the direction toward a passenger compartment of the motor vehicle; and an insulating element which comprises an expanded material, wherein the expanded material closes the passage against the first region; wherein the expanded material is a foamed and at least partially cured epoxy resin composition.

This solution firstly has the advantage that in automotive manufacture already known materials can be used in order to achieve this new intended application. Epoxy-based compositions which are expanded in this manner under the action of heat are often used to reinforce body sections. These materials have a very high mechanical loading capacity in an expanded and cured state. Often, such materials are referred to as reinforcing adhesives or “expanding reinforcer materials”, “reinforcer foams”, “reinforcer materials” or “expanding adhesives”.

Consequently, an advantage of the solution proposed herein is that materials which are known and have been found to be advantageous for achieving the objective set out in the introduction can be used. For example, such materials do not have to be authorized again for automotive manufacturers, whereby costs and complexity can be saved.

The solution proposed herein further affords the advantage that, by using an expandable material, a simple and efficient insulation of a passage is enabled. Such insulating elements proposed here can be fitted in a non-expanded state in the body and are then expanded and cured in a furnace during the painting of the body. Consequently, handling, installation and planning of such insulating elements are simple and cost-effective.

The term “insulating element” or “insulation” or “insulated” is intended to include in connection with this invention elements or structures or method steps for shielding and/or closing and/or insulating a passage. The different properties of such an insulating element can occur individually or in combination with each other in this case.

In an exemplary embodiment, the passage is configured in a channel-like manner.

In an exemplary embodiment, the passage is formed by side walls which surround an empty space.

In an alternative embodiment, the passage is configured in a hole-like manner. In this case, the passage is particularly formed by an opening in a wall.

In an exemplary embodiment, the insulating element exposes only expanded material toward the first region.

Such an arrangement of expanded material affords the advantage that the cured epoxy resin composition forms an effective protective shield with respect to the poisonous and hot gases which come from the battery which is running away. This is because it has been found in experiments that many other materials withstand such loading for an insufficiently long time. Consequently, it is advantageous if only this resistant, expanded material is exposed to the hot gas and no other components of the insulating element (such as, for example, portions of a carrier or the like).

In an exemplary embodiment, the expanded material has a layer thickness measured in a direction along a main passage axis of the passage between 1 and 50 mm. Preferably, this layer thickness is between 2 mm and 30 mm, particularly preferably between 5 mm and 20 mm.

This is because it has been found in experiments that a specific layer thickness is required to withstand the loading by the hot gas for a sufficiently long time. In tests, an uppermost layer of the cured epoxy resin composition during loading by the hot gas was carbonized, but underlying layers of the cured epoxy resin composition remained intact. Consequently, a sufficiently thick layer must be provided to be able to withstand the loading by the hot gas for a sufficient length of time.

In an exemplary embodiment, the expanded material has before expansion, that is to say, the expandable material, a layer thickness measured in a direction along a main passage axis of the passage between 1 mm and 10 mm. This layer thickness is preferably between 2 mm and 7 mm, particularly preferably between 3 mm and 6 mm.

In an exemplary embodiment, the insulating element further comprises a carrier.

The provision of a carrier affords the advantage that the expanded material can be positioned more simply and accurately in the motor vehicle before expansion.

In an exemplary further development, the carrier is in the form of a film. In particular, the carrier is configured in a flexible manner. In another exemplary embodiment, the carrier can be made from metal.

In an alternative embodiment, the carrier is in the form of a rigid carrier, wherein the carrier is particularly made from plastics material.

In an exemplary further development, the carrier and expanded material were produced by a two-component injection-molding method.

In an exemplary embodiment, the insulating element does not comprise a carrier.

This affords the advantage that the insulating element can thereby be produced in a more cost-effective manner, for example, by an extrusion method.

In an exemplary further development, the insulating element is secured to a structure of the passage by an adhesive film.

This has the advantage that the expandable material can be positioned in the region of the passage before expansion.

In another exemplary further development, the insulating element is secured to a structure of the passage by a push-pin.

This method also affords the advantage that the expandable material can be prefixed before expansion without any carrier at a desired position in the region of the passage.

In an exemplary embodiment, the system is in a motor vehicle without an internal combustion engine.

In an alternative embodiment, the system is in a motor vehicle with an electric drive and with an internal combustion engine (in particular in a hybrid vehicle).

The term “battery of the motor vehicle” is intended to be understood in the context of this invention to be a battery which is used to supply an electric drive with energy. It is expressly not intended to be understood to be a battery which is used to start an internal combustion engine.

### Expanded Material

In a state for use, that is to say, a system of an insulated passage, which is present in a finished automobile, the originally expandable material is in the form of expanded material. However, specific properties of this expanded material can be better described using a state before expansion. In the more detailed description of this material below, therefore, reference may be made in places to the expanded material after expansion and in places to the expandable material before expansion.

In an exemplary embodiment, the expanded material has a volume which is greater by between 50% and 1200% than before expansion. In a preferred further development, the volume increases by between 100 and 1000%, preferably between 200 and 800%.

In an exemplary embodiment, the expanded material is a foamed and cured epoxy composition.

In an exemplary embodiment, the expanded material is obtained from a one-component, thermally curing epoxy resin composition.

In an exemplary embodiment, the expanded material (3′) was in the form of an expandable material (3) which contained the following composition:
one-component, thermally curing epoxy resin composition comprising:
   a) at least one epoxy resin A with on average more than one epoxy group per molecule;
   b) at least one latent curing agent for epoxy resins; and
   c) at least one physical or chemical propellant BA.

In an exemplary embodiment, the proportion of the epoxy resin A with on average more than one epoxy group per molecule is from 30 to 90% by weight, from 35 to 85% by weight, from 40 to 75% by weight, more preferably from 45 to 60% by weight with respect to the total weight of the thermally curable one-component epoxy resin composition.

In an exemplary embodiment, the epoxy resin A is a solid epoxy resin.

In an exemplary embodiment, the thermally curable one-component epoxy resin composition further comprises
d) at least one viscosity enhancer D.

In an exemplary embodiment, the viscosity enhancer D is selected from the group comprising terminally blocked polyurethane polymers D1, liquid rubbers D2 and core/shell polymers D3.

In an exemplary embodiment, the latent curing agent is selected from dicyandiamide, guanamines, guanidines, aminoguanidines and derivatives thereof, substituted ureas, imidazoles and amino complexes, preferably dicyandiamide.

In an exemplary embodiment, the thermally curable one-component epoxy resin composition further comprises at least one filler F which is selected from the group comprising calcium carbonate, calcium oxide, talcum, glass fibers and pyrogenic silicic acids, more preferably talcum, glass fibers and pyrogenic silicic acids.

In an exemplary embodiment, the thermally curable one-component epoxy resin composition further comprises at least one flame-retardant component G. In particular, the flame-retardant component G is selected from the list comprising ammonium phosphate, ammonium pyrophosphate, ammonium polyphosphate, melamine phosphate, magnesium sulphate and boric acid, preferably ammonium polyphosphate.

Preferably, the ammonium polyphosphate has a particle size of <100 μm, in particular from 50 μm to 5 μm,

The total proportion of the flame-retardant component G is advantageously from 3 to 50% by weight, preferably from 5 to 40% by weight, from 8 to 35% by weight with respect to the total weight of the epoxy resin composition.

It is further advantageous if the ammonium polyphosphate is an ammonium polyphosphate having the formula (NH4PO3)n with n being from 200 to 2000, preferably from 600 to 1500.

In an exemplary embodiment, the proportion of the propellant BA is from 0.1 to 10% by weight, preferably from 0.5 to 5% by weight, in particular from 1 to 3% by weight with respect to the total weight of the epoxy resin composition.

The epoxy resin composition has a single component, which means that the components of the epoxy resin composition, in particular the epoxy resin and the curing agent, are present in one component without curing taking place at conventional ambient or surrounding temperature. Therefore, it can be handled in this form while, in the case of two-component systems, the components can be mixed only directly before use.

The curing of the one-component epoxy resin composition is carried out by heating, typically at a temperature of more than 70° C., for example, in the range from 100 to 220° C.

The prefix “poly” in expressions such as polyol or polyisocyanate means that the compound has two or more of the groups mentioned. A polyisocyanate is, for example, a compound with two or more isocyanate groups.

The expression “independently of each other” used below means that in the same molecule two or more identically designated substituents may have the same or different meanings as defined.

The broken lines in the formulae of this document each represent the bond between the relevant substituents and the associated remainder of the molecule.
Ambient temperature refers here to a temperature of 23° C. unless otherwise indicated.

The thermally curable one-component epoxy resin composition contains at least one epoxy resin A with on average more than one epoxy group per molecule. The epoxy group preferably takes the form of a glycidyl ether group.

The proportion of the epoxy resin A with on average more than one epoxy group per molecule is preferably from 30 to 90% by weight, from 35 to 85% by weight, from 40 to 75% by weight, particularly preferably from 45 to 60% by weight with respect to the total weight of the thermally curable one-component epoxy resin composition.

The epoxy resin A with on average more than one epoxy group per molecule is preferably a liquid epoxy resin or a solid epoxy resin, particularly preferably a solid epoxy resin. The term “solid epoxy resin” is very commonplace to the person skilled in the art in the field of epoxides and is used in contrast to “liquid epoxy resins”. The glass transition temperature of solid resins is above ambient temperature so that they can be comminuted at ambient temperature to form pourable powders. Preferably, more than 70% by weight, particularly preferably more than 80% by weight, more than 90% by weight, more than 95% by weight, more than 98% by weight of the epoxy resin A is a solid epoxy resin.

Preferred epoxy resins have the formula (II)

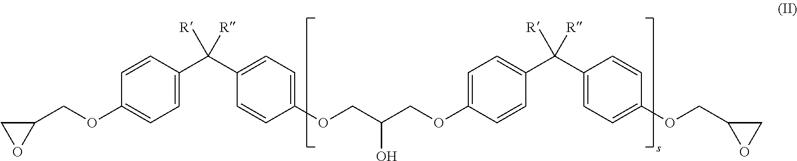

In this formula, the substituents R′ and R″ mean independently of each other either H or CH₃.

In solid epoxy resins, the index s has a value of >1.5, in particular from 2 to 12.

Such solid epoxy resins are commercially available, for example from Dow or Huntsman or Hexion.

Compounds having the formula (II) with an index s from 1 to 1.5 are referred to by the person skilled in the art as semi-solid epoxy resins. They are also considered in the context of the present invention to be solid resins. However, preferred solid epoxy resins are epoxy resins in the narrower sense, that is to say, in which the index s has a value >1.5.

In liquid epoxy resins, the index s has a value less than 1. Preferably, s has a value less than 0.2.

Therefore, it is preferably diglycidyl ether of bisphenol A (DGEBA), of bisphenol F and of bisphenol A/F. Liquid resins of this type are available, for example, as Araldite® GY 250, Araldite® PY 304, Araldite® GY 282 (Huntsman) or DER™ 331 or DER™ 330 (Dow) or Epikote 828 (Hexion).

The epoxy resin A is preferably a solid epoxy resin having the formula (II).

The thermally curable one-component epoxy resin composition further comprises at least one latent curing agent for epoxy resins. Latent curing agents are substantially inert at ambient temperature and are activated by increased temperatures, typically at temperatures of 70° C. or more, whereby the curing reaction is initiated. The conventional latent curing agents for epoxy resins can be used. A nitrogen-containing latent epoxy resin curing agent is preferred.

The latent curing agent is preferably selected from dicyandiamide, guanamines, guanidines, aminoguanidines and derivatives thereof, substituted ureas, imidazoles and amine complexes, preferably dicyandiamide.

The latent curing agent is preferably used in a stochiometric quantity with respect to the epoxy groups in the composition. The molar ratio of the epoxy groups to the active hydrogen of the latent curing agent is preferably from 0.8 to 1.2, in particular from 0.9 to 1.1, preferably from 0.95 to 1.05.

The proportion of the latent curing agent is preferably from 0.1 to 15% by weight, particularly preferably from 0.2 to 5% by weight, in particular from 0.5 to 3% by weight, with respect to the total weight of the epoxy resin composition.

The thermally curable one-component epoxy resin composition optionally contains at least one viscosity enhancer D. The viscosity enhancers D may be solid or liquid. In particular, the viscosity enhancer D is selected from the group comprising terminally blocked polyurethane polymers D1, liquid rubbers D2 and core/shell polymers D3.

The proportion of viscosity enhancers D is preferably from 5 to 30% by weight, particularly preferably from 7.5 to 20% by weight with respect to the total weight of the epoxy resin composition.

In a preferred embodiment, the thermally curable one-component epoxy resin composition further comprises at least one filler F. In this case, mica, talcum, kaolin, wollastonite, feldspar, syenite, chlorite, bentonite, montmorillonite, calcium carbonate (precipitated or ground), dolomite, quartz, silicic acids (fumed or precipitated), cristobalite, calcium oxide, aluminium hydroxide, magnesium oxide, ceramic hollow beads, glass hollow beads, organic hollow beads, glass beads, glass fibers and colour pigments. Particularly preferably, fillers are selected from the group comprising calcium carbonate, calcium oxide, talcum, glass fibers and pyrogenic silicic acids, more preferably talcum, glass fibers and pyrogenic silicic acids.

The total proportion of the entire filler F is advantageously from 3 to 50% by weight, preferably from 5 to 40% by weight, from 8 to 35% by weight, with respect to the total weight of the epoxy resin composition.

The thermally curable one-component epoxy resin composition comprises at least one physical or chemical propellant BA.

Chemical propellants are organic or inorganic substances which form or split off gaseous substances under the influence of temperature, moisture, electromagnetic radiation or chemicals. Such substances are particularly azodicarbonamides, sulphohydrazides, hydrogen carbonates or carbonates. Compounds which, for example, change into the gaseous aggregate state in the event of changes in temperature, pressure or volume, in particular in the event of a temperature increase, and which thus form a foam structure as a result of volume expansion can be used as physical propellants. Such physical propellants are in particular liquids which evaporate at increased temperature. Furthermore, gases or low-boiling liquids which are introduced into the composition in micro-encapsulated form can be used as physical propellants. Both chemical and physical propellants are capable of generating foam structures in polymer compositions.

The at least one physical or chemical propellant BA preferably has an activation temperature of from 120° C. to 220° C., preferably from 140° C. to 200° C.

The proportion of the propellant BA is advantageously from 0.1 to 10% by weight, preferably from 0.5 to 5% by weight, in particular from 1 to 3% by weight, with respect to the total weight of the epoxy resin composition.

A particularly preferred thermally curable one-component epoxy resin composition comprises:
from 30 to 90% by weight, from 35 to 85% by weight, from 40 to 75% by weight, particularly preferably from 45 to 60% by weight, with respect to the total weight of the thermally curable epoxy resin composition, the at least one epoxy resin A has on average more than one epoxy group per molecule;
from 0.1 to 15% by weight, particularly preferably from 0.2 to 5% by weight, in particular from 0.5 to 3% by weight, with respect to the total weight of the thermally curable epoxy resin composition, the at least one latent curing agent for epoxy resins, more particularly dicyandiamide;
from 0.1 to 10% by weight, preferably from 0.5 to 5% by weight, in particular from 1 to 3% by weight with respect to the total weight of the thermally curable epoxy resin composition, the propellant BA;
preferably from 5 to 30% by weight, preferably from 7.5 to 20% by weight of at least one viscosity enhancer D, with respect to the total weight of the thermally curable epoxy resin composition;
preferably from 5 to 40% by weight, preferably from 20 to 40% by weight with respect to the total weight of the thermally curable epoxy resin composition, a filler F selected from the group comprising calcium carbonate, calcium oxide, talcum, glass fibers and pyrogenic silicic acids, more preferably talcum, glass fibers and pyrogenic silicic acids;
optionally from 3 to 50% by weight, preferably from 5 to 40% by weight, in particular from 8 to 35% by weight, with respect to the total weight of the thermally curable epoxy resin composition, at least one flame-retardant component G selected from the list comprising ammonium phosphate, ammonium pyrophosphate, ammonium polyphosphate, melamine phosphate, magnesium sulphate and boric acid, preferably ammonium polyphosphate.

Furthermore, it may be advantageous for the preferred thermally curable one-component epoxy resin composition to comprise the above-mentioned constituents at more than 80% by weight, preferably at more than 90% by weight, in particular at more than 95% by weight, particularly preferably at more than 98% by weight with respect to the total weight of the epoxy resin composition.

Details and advantages of the invention are described below with reference to exemplary embodiments and schematic drawings, in which:

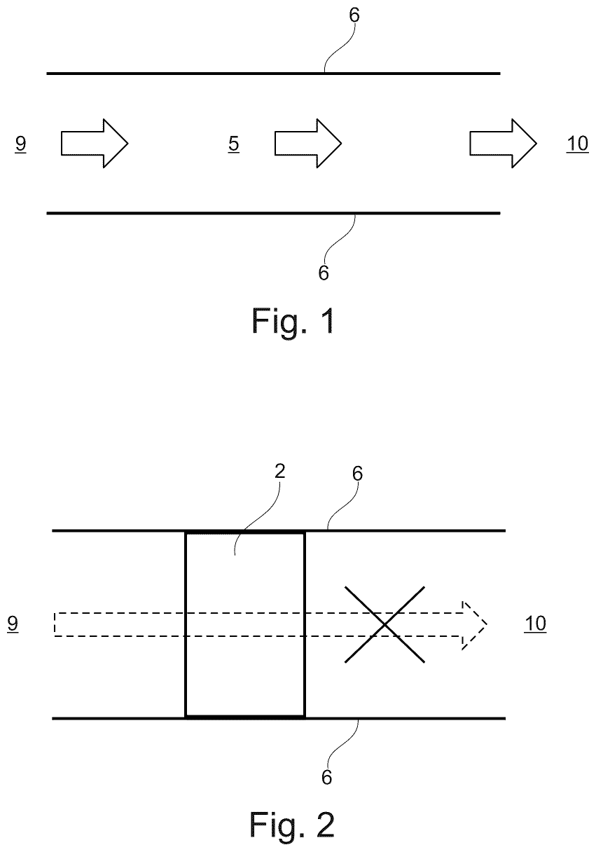

FIG. 1 shows an exemplary illustration of a passage;

FIG. 2 shows an exemplary illustration of a passage with an insulating element arranged therein; and

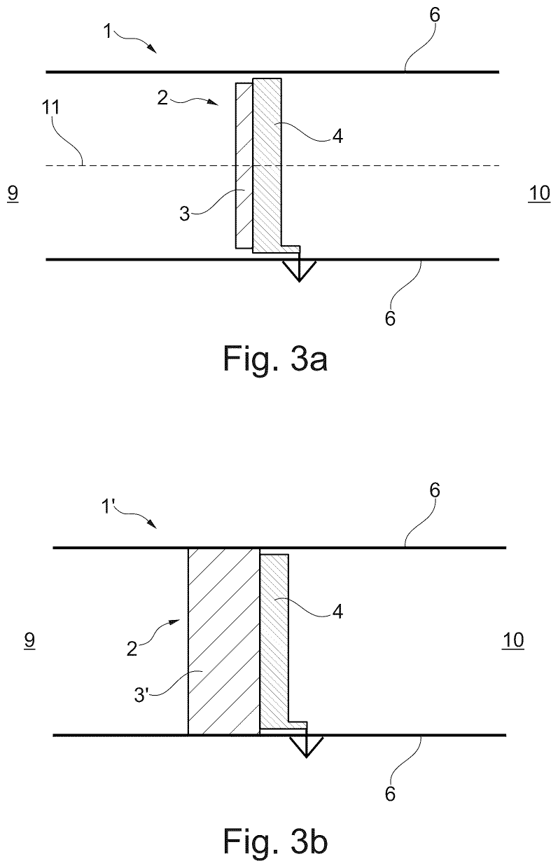

FIGS. 3a to 6b show exemplary illustrations of systems of insulated passages.

FIG. 1 illustrates by way of example a passage 5 in an electrically driven motor vehicle. In this case, the passage 5 connects a first region 9 to a second region 10. The first region 9 is air-permeable in the direction toward a battery of the motor vehicle and the second region 10 is air-permeable in the direction toward a passenger compartment of the motor vehicle. In this exemplary embodiment, the passage 5 is in the form of a channel-like passage, wherein side walls 6 surround an empty space. Furthermore, arrows indicate the direction in which hot and poisonous gas propagates in the event of a thermal runaway of the battery of the motor vehicle.

FIG. 2 again illustrates a passage 5 in an electrically driven motor vehicle. However, this passage 5 is now insulated by an insulating element 2 in FIG. 2. This insulating element 2 accordingly prevents hot and poisonous gases from being able to propagate from the first region 9 toward the second region 10. This is illustrated in this Figure with a broken and crossed-out arrow.

Exemplary and possible embodiments of such insulating elements 2 are now schematically and incompletely illustrated in the following Figures. In this case, for each exemplary embodiment the system 1 is illustrated once in a state before expansion of the expandable material 3 and also after the expansion of the expandable material 3. The systems 1 after expansion, that is to say, with the expanded material 3′, are each denoted as system 1′.

FIGS. 3a and 3b illustrate a first exemplary system 1 or 1′. In this exemplary embodiment, the passage 5 is again formed in a channel-like manner with side walls 6. In this case, the insulating element 2 is positioned in this passage in such a manner that the expanded material 3′ closes the passage. In this case, the expanded material is orientated toward the first region 9. In this exemplary embodiment, the insulating element 2 comprises both expandable material 3 or expanded material 3′ and a carrier 4. This carrier 4 further has in this exemplary embodiment a clip which simplifies a positioning in the region of the passage.

In FIG. 3a, a main passage direction 11 through the passage 5 is depicted. In this exemplary embodiment, this main passage direction 11 extends substantially parallel with the side walls 6.

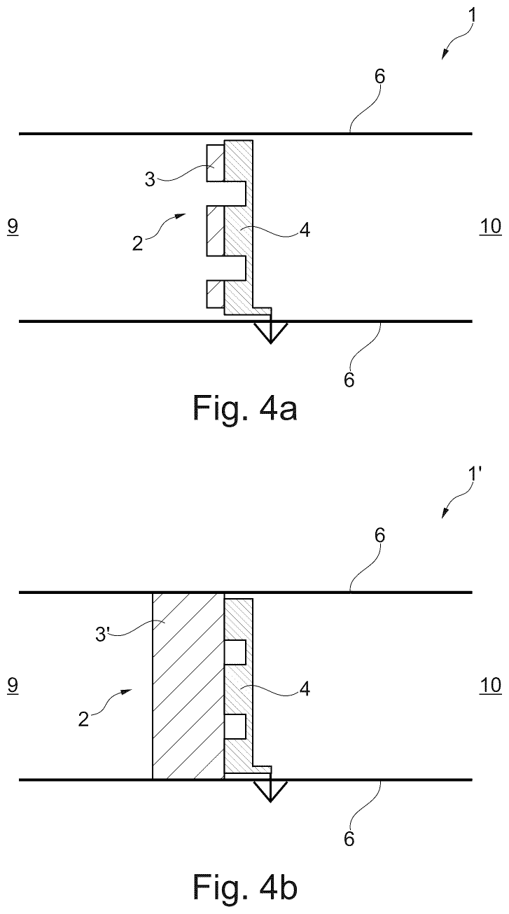

FIGS. 4a and 4b illustrate an additional example of a system 1 or 1′ of an insulated passage. Unlike the exemplary embodiment of FIGS. 3a and 3b, both the carrier 4 and the expandable material 3 do not form before expansion of the material a continuous surface at the side of the first region 9. However, FIG. 4b shows that, in the state for use of the system 1′, the expanded material 3′ completely closes the passage 5 in the direction toward the first region 9. The insulating effect of the insulating element 2 against hot and poisonous gases is thereby completely achieved.

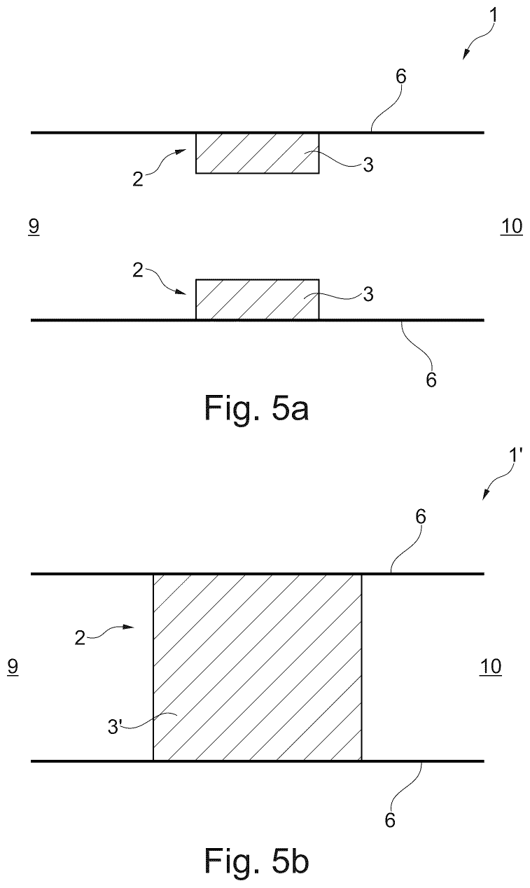

FIGS. 5a and 5b now illustrate an insulating element 2 which does not comprise a carrier. The insulating element 2 in this exemplary embodiment is fixed to a structure in the region of the passage 5 by an adhesive layer. The expanded material 3′ again completely closes the passage 5 in a state for use of the system 1′.

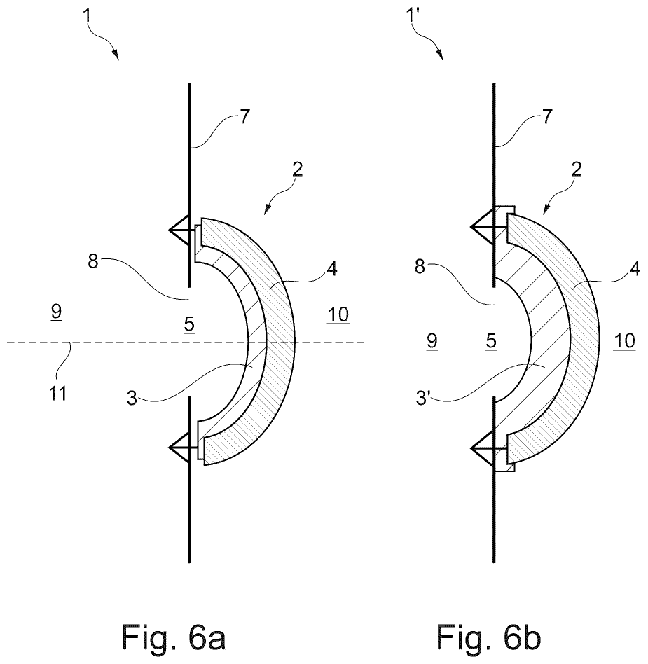

Finally, FIGS. 6a and 6b illustrate an additional exemplary embodiment of a system 1 or 1′. In this exemplary embodiment, the passage 5 is configured in a hole-like manner wherein the passage 5 is formed by an opening 8 in a wall 7. In this exemplary embodiment, the main passage direction 11 extends substantially perpendicularly to the wall 7.

In this case, the insulating element 2 again comprises a carrier 4 and expandable material 3 or expanded material 3′. After expansion of the expandable material 3, the expanded material closes the passage 5 against the first region 9, as can be seen in FIG. 6b.

### LIST OF REFERENCE NUMERALS

1 System (before a state for use)
1′ System (in a state for use)
2 Insulating element
3 Expandable material
3′ Expanded material
4 Carrier
5 Passage
6 Side wall
7 Wall
8 Opening
9 First region
10 Second region
11 Main passage axis

1. A system of an insulated passage in an electrically driven motor vehicle, the system comprising:
a passage which connects a first region to a second region, wherein the first region is air-permeable in the direction toward a battery of the motor vehicle and wherein the second region is air-permeable in the direction toward a passenger compartment of the motor vehicle; and
an insulating element which comprises an expanded material, wherein the expanded material closes the passage against the first region;
wherein the expanded material is a foamed and at least partially cured epoxy resin composition.

2. The system as claimed in claim 1, wherein the passage is formed in a channel-like manner and/or wherein the passage is formed by side walls which surround an empty space.

3. The system as claimed in claim 1, wherein the passage is configured in a hole-like manner and/or wherein the passage is formed by an opening in a wall.

4. The system as claimed in claim 1, wherein the insulating element exposes only expanded material towards the first region.

5. The system as claimed in claim 1, wherein the expanded material has a layer thickness measured in a direction along a main passage axis of the passage between 1 and 50 mm.

6. The system as claimed in claim 1, wherein the expanded material has a volume which is between 50% and 1200% greater than before expansion.

7. The system as claimed in claim 1, wherein the expanded material was present in the form of an expandable material which contained the following composition before expansion:
one-component, thermally curing epoxy resin composition comprising:
a) at least one epoxy resin A with on average more than one epoxy group per molecule;
b) at least one latent curing agent for epoxy resins; and
c) at least one physical or chemical propellant BA.

8. The system as claimed in claim 1, wherein the insulating element comprises a carrier.

9. The system as claimed in claim 8, wherein the carrier is in the form of a film and/or wherein the carrier is configured in a flexible manner and/or wherein the carrier is made from metal.

10. The system as claimed in claim 8, wherein the carrier is in the form of a rigid carrier and/or wherein the carrier is made from plastics material.

11. The system as claimed in claim 10, wherein the carrier and expandable material were produced by a two-component injection-molding method.

12. The system as claimed in claim 1, wherein the insulating element does not comprise any carrier.

13. The system as claimed in claim 12, wherein the insulating element is secured to a structure of the passage by an adhesive film.

14. The system as claimed in claim 12, wherein the insulating element is secured to a structure of the passage by a push-pin.

15. The system as claimed in claim 1, wherein the system is in a motor vehicle without an internal combustion engine.
